(19) United States
(12) Patent Application Publication
(10) Pub. No.: US 2011/0050578 A1
(43) Pub. Date: Mar. 3, 2011

(54) ELECTRONIC DEVICE WITH SWITCHABLE INPUT MODES AND METHOD THEREOF

(75) Inventors: Teh-Shen Lee, Tu-Cheng (TW); Kuan-Hong Hsieh, Tu-Cheng (TW); Chiung-Li Chang, Tu-Cheng (TW)

(73) Assignee: HON HAI PRECISION INDUSTRY CO., LTD., Tu-Cheng (TW)

(21) Appl. No.: 12/730,214

(22) Filed: Mar. 23, 2010

(30) Foreign Application Priority Data
Aug. 28, 2009 (CN) 200910306262.X

(51) Int. Cl. G06F 3/02

(52) U.S. Cl. 345/168; 345/173

(57) ABSTRACT

A method of switching input modes includes: generating a switch signal in response to user input; recording a duration of the switch signal; comparing the recorded duration of the switch signal with a predetermined time interval; generating a first switch signal if the recorded duration of the switch signal is equal to or greater than the predetermined time interval, or generating a second switch signal if the recorded duration of the switch signal is less than the predetermined time interval; and switching a first input mode to a second input mode according to the first switch signal, or switching the second input mode to the first input mode according to the second switch signal.

### BACKGROUND

1. Technical Field

The present disclosure relates to electronic devices and, particularly, to an electronic device with selectable input modes and a method thereof.

2. Description of Related Art

Portable electronic devices including a touch screen are very popular. However, users may accidentally press some keys when they are using the touch screen or accidentally touch the touch screen when using the keys of the electronic device.

### BRIEF DESCRIPTION OF THE DRAWINGS

The components of the drawings are not necessarily drawn to scale, the emphasis instead being placed upon clearly illustrating the principles of an electronic device with switchable input modes and a method thereof. Moreover, in the drawings, like reference numerals designate corresponding parts throughout several views.

FIG. 1 is a block diagram of an electronic device with switchable input modes in accordance with an exemplary embodiment.

FIG. 2 is a flowchart of a method of switching input modes of an electronic device in accordance with an exemplary embodiment.

### DETAILED DESCRIPTION

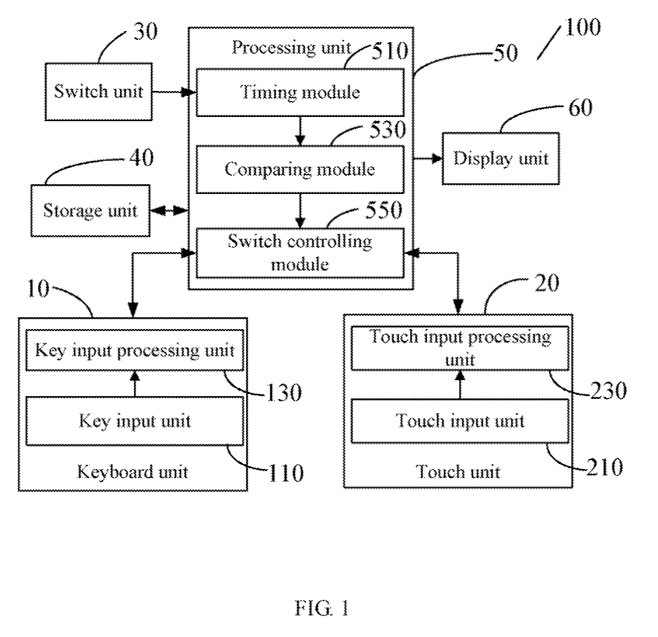

Referring to FIG. 1, an embodiment of an electronic device 100 with switchable input modes is illustrated. In the embodiment, the electronic device 100 includes a key input mode and a touch input mode. In the key input mode, users can only input symbols or commands to the electronic device 100 through pressing keys of a keyboard of the electronic device. In the touch input mode, users can only input symbols or commands to the electronic device 100 through touching a touch screen of the electronic device 100.

The electronic device 100 at least includes a keyboard unit 10, a touch unit 20, a switch unit 30, a storage unit 40, a processing unit 50, and a display unit 60.

The keyboard unit 10 includes a key input unit 110 and a key input processing unit 130. The key input unit 110 is configured for generating input signals in response to user input. The key input processing unit 130 is configured for processing the input signals transmitted from the key input unit 110 and transmitting the processed input signals to the processing unit 50.

The touch unit 20 includes a touch input unit 210 and a touch input processing unit 230. The touch input unit 210 is configured for generating input signals in response to user inputs. The touch input processing unit 230 is configured for processing the input signals transmitted from the touch input unit 210 and transmitting the processed input signals to the processing unit 50.

The switch unit 30 is configured for generating a switch signal in response to user inputs. The switch unit 30 can be a physical key or a soft key expressed by a displayed icon.

The storage unit 40 is configured for storing a predetermined time interval T.

The processing unit 50 includes a timing module 510, a comparing module 530, and a switch controlling module 550. The timing module 510 is configured for recording a duration T1 of the switch signal transmitted from the switch unit 30. The comparing module 530 is configured for comparing T with T1. In the embodiment, if T1 is equal to or greater than T, the comparing module 530 generates a touch input switch signal. If T1 is less than T, the comparing module 530 generates a key input switch signal. In an alternative embodiment, if T1 is equal to or greater than T, the comparing module 530 generates the key input switch signal, and if T1 is less than T, the comparing module 530 generates the touch input switch signal. The switch controlling module 550 is configured for switching the key input mode to the touch input mode according to the touch input switch signal, or switching the touch input mode to the key input mode according to the key input switch signal.

The display unit 60 is configured for displaying a graphic user interface. In the embodiment, the display unit 60 is a touch screen.

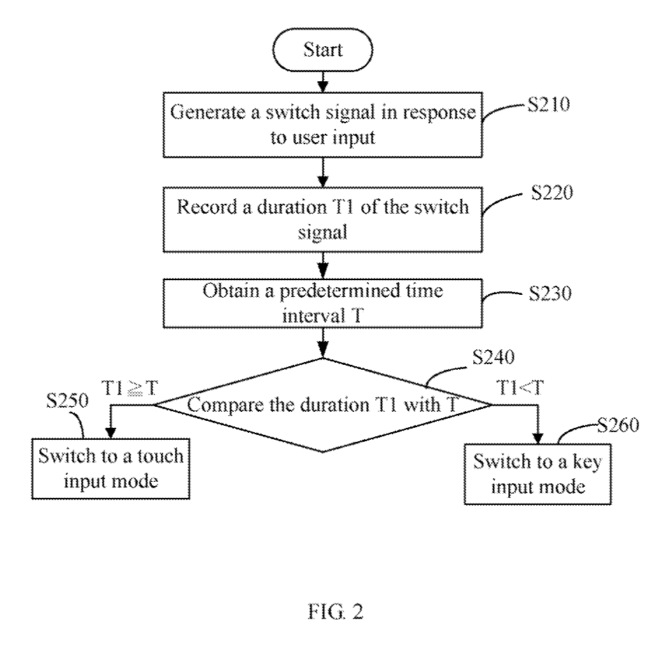

FIG. 2 is a flowchart of a method of switching input modes of the electronic devices 100 in accordance with an exemplary embodiment.

In step S210, the switch unit 30 generates a switch signal in response to user inputs.

In step S220, the timing module 510 records T1 of the switch signal.

In step S230, the processing unit 50 obtains the T from the storage unit 40.

In step S240, the comparing module 530 compares T1 of the switch signal with T. If T1 of the switch signal is equal to or greater than T, the comparing module 530 generates the touch input switch signal, and the procedure goes to step S250. If T1 of the switch signal is less than T, the comparing module 530 generates the key input switch signal, and the procedure goes to step S260.

It should be noted that in an alternative embodiment if T1 of the switch signal is less than T, the comparing module 530 generates the touch input switch signal. If T1 of the switch signal is equal to or greater than T, the comparing module 530 generates the key input switch signal.

In step S250, the switch controlling module 550 switches the key input mode to the touch input mode.

In step S260, the switch controlling module 260 switches the touch input mode to the key input mode.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with switchable input modes, comprising:
a keyboard unit configured for generating key input signal in response to user input;
a touch unit configured for generating touch input signal in response to user input;
a switch unit configured for generating a switch signal in response to user input;
a storage unit configured for storing a predetermined time interval; and
a processing unit comprising:
a timing module configured for recording a duration of the switch signal transmitted from the switch unit;
a comparing module configured for comparing the recorded duration of the switch signal with the predetermined time interval, and generating a first switch signal if the recorded duration is equal to or greater than the predetermined time interval, or generating a second switch signal if the recorded duration is less than the predetermined time interval; and
a switch controlling module configured for switching a first input mode to a second input mode according to the first switch signal, or switching the second input mode to the first input mode according to the second switch signal.

2. The electronic device as described in claim 1, wherein the first switch signal is the touch input switch signal, and the second switch signal is the key input switch signal, the first input mode is the key input mode, and the second input mode is the touch input mode.

3. The electronic device as described in claim 1, wherein the first switch signal is the key input switch signal, and the second switch signal is the touch input switch signal, the first input mode is the touch input mode, and the second input mode is the key input mode.

4. The electronic device as described in claim 1, further comprising a touch screen.

5. A method of switching input modes, comprising:
generating a switch signal in response to user input;
recording a duration of the switch signal;
comparing the recorded duration of the switch signal with a predetermined time interval;
generating a first switch signal if the recorded duration of the switch signal is equal to or greater than the predetermined time interval, or generating a second switch signal if the recorded duration of the switch signal is less than the predetermined time interval; and
switching a first input mode to a second input mode according to the first switch signal, or switching the second input mode to the first input mode according to the second switch signal.

6. The method as described in claim 5, wherein the first switch signal is the touch input switch signal, and the second switch signal is the key input switch signal, the first input mode is the key input mode, and the second input mode is the touch input mode.

7. The method as described in claim 5, wherein the first switch signal is the key input switch signal, and the second switch signal is the touch input switch signal, the first input mode is the touch input mode, and the second input mode is the key input mode.
